(19) United States
(12) Patent Application Publication
(10) Pub. No.: US 2007/0146844 A1
(43) Pub. Date: Jun. 28, 2007

(54) Holographic recording medium, holographic recording apparatus, holographic recording medium, and holographic memory reproducing method and apparatus

(75) Inventors: Takuya Tsukagoshi, Kanagawa (JP); Jiro Yoshinari, Tokyo (JP); Hideaki Miura, Tokyo (JP); Tetsuro Mizushima, Oosaka (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 10/588,231

(22) PCT Filed: Jan. 6, 2005
(86) PCT No.: PCT/JP05/00083

§ 371 Date: Aug. 3, 2006

(30) Foreign Application Priority Data
Feb. 17, 2004 (JP) 2004-39503

(51) Int. Cl. G03H 1/26

(52) U.S. Cl. 359/22

(57) ABSTRACT

A holographic recording and reproducing apparatus 10 can simultaneously reproduce a plurality of data images by the single application of a reproduction reference beam in reproducing holograms. In the holographic recording and reproducing apparatus 10, an object beam is projected from a fixed object beam incident optical axis 18A to a holographic recording medium 16, and a reference beam is incident on the holographic recording medium 16 selectively from a plurality of incident optical axes 38A to 38C by modulating the angle of a rotating mirror 32 in many stages. A rotating stage 36 rotates the holographic recording medium 16 in such a manner that the holographic recording medium 16 has a constant angle with respect to the reference beam selectively incident thereon via each incident optical axis 38A, 38B, or 38C. When reproducing data images, the projection of a single reference beam generates a plurality of diffracted light beams in different directions in response to the rotational angle of the holographic recording medium 16 at the time of recording, and three imaging devices 22A, 22B, and 22C simultaneously receive the diffracted light beams.

### TECHNICAL FIELD

The present invention relates to a holographic recording method and a holographic recording apparatus in which an object beam and a reference beam are projected onto a holographic recording medium to record information by interference fringes, the holographic recording medium on which the information is recorded thereby, and a holographic memory reproducing method and apparatus for reproducing the information recorded on the holographic recording medium.

### BACKGROUND ART

Demand for a data storage technology which can store a large amount of digital information is increasing in recent years, and holographic memory technology is promising as one of the next generation high-capacity and high-speed storage technologies.

In the holographic memory technology, since the digital information is encoded into a two-dimensional bitmap image on a few hundred thousand to a few million bits basis and is recorded and reproduced at a time, it is possible to transfer a large amount of data at high speed. Also using the diffraction and interference of light can superimpose (multiplex recording) many data pages on a specific region of a holographic recording medium, so that high-capacity storage becomes available.

As a method for high-capacity recording, as published in G. Barbastathis et al., Applied Optics, Vol. 35, No. 14, p.2403-2417, there is a method of shift multiplex recording by which the incident position of a reference beam and an object beam on a recording medium is shifted in succession.

When reproducing the data page recorded on the holographic recording medium as described above, a reproduction reference beam is projected onto the holographic recording medium. An imaging device receives generated diffracted light to reproduce the data pages.

A frame rate of the imaging device restrains an upper limit to the reproduction speed of the foregoing data pages. Thus, there is a problem that the frame rate of the imaging device is slow at a several tens fps in general.

To cope with this, using a high-speed CCD camera and the like can make the frame rate fast, but they are expensive. There is the problem of increasing in device costs.

Also in holographic recording, a data rate at the time of reproduction is generally reduced with increase in recording density, and there is a problem that a tradeoff occurs between the data rate and the recording density.

### DISCLOSURE OF THE INVENTION

The present invention has been devised in view of the aforementioned problems. It is therefore an object of the present invention to provide a holographic recording method and a holographic recording apparatus by which a reproduction data rate can be increased without reducing recording density using imaging devices, a holographic recording medium on which information is recorded by these method and apparatus, and a holographic memory reproducing method and apparatus for reproducing the information recorded on the holographic recording medium.

As a result of intensive studies, the inventor has found that the relative incident angle of a reference beam is fixed with respect to a recording layer of a holographic recording medium, and the angle of the reference beam and the recording layer with respect to an object beam is varied in stages to record data pages by deflection multiplex recording. At the time of reproduction, the irradiation of a single reproduction reference beam simultaneously generates a plurality of diffracted light beams in different directions, and the imaging devices receives them at the same time, thereby achieving the aforementioned objects.

In Summary, the above-described objectives are achieved by the following aspects of the present invention.

(1) A holographic recording method comprising the step of projecting a reference beam and an object beam onto a holographic recording medium to form a diffraction grating in a recording layer in the vicinity of a point of intersection of an incident optical axis of the reference beam and an incident optical axis of the object beam, thereby recording information, wherein the holographic recording medium is rotated in an optical axial plane including the incident optical axes of the reference beam and the object beam in a plurality of stages with respect to the point of intersection while keeping an incident angle of the object beam constant, and the incident optical axis of the reference beam is switched in a plurality of stages synchronously with a rotational angle of the holographic recording medium so as to keep a relative incident angle to the holographic recording medium constant to carry out deflection multiplex recording.

(2) The holographic recording method according to (1), wherein the holographic recording medium is relatively shifted in X and Y axial directions to carry out the deflection multiplex recording and shift multiplex recording, when a rotational central axis of the holographic recording medium represents a Y axis, a direction approximately perpendicular to the recording layer represents a Z axis, and a direction perpendicular to the Y axis and the Z axis represents an X axis.

(3) The holographic recording method according to (2) having a process of shifting the holographic recording medium in the X axial direction while keeping the incident optical axis of the object beam, the incident optical axis of the reference beam, and the rotational angle of the holographic recording medium constant to carry out the shift multiplex recording in the X axial direction, and then a process of shifting the holographic recording medium in the Y axial direction to carry out the shift multiplex recording in the Y axial direction, wherein whenever the incident optical axis of the reference beam and the rotational angle of the holographic recording medium corresponding thereto are switched, the process of the X axial shift multiplex recording by shifting the holographic recording medium in the X axial direction and the process of the Y axial shift multiplex recording by shifting the holographic recording medium in the Y axial direction are repeated.

(4) The holographic recording method according to (2) having a process of shifting the holographic recording medium in the Y axial direction while keeping the incident optical axis of the object beam, the incident optical axis of the reference beam, and the rotational angle of the holographic recording medium constant to carry out the shift multiplex recording in the Y axial direction, and then a process of shifting the holographic recording medium in the X axial direction to carry out the shift multiplex recording in the X axial direction, wherein whenever the incident optical axis of the reference beam and the rotational angle of the holographic recording medium corresponding thereto are switched, the process of the Y axial shift multiplex recording by shifting the holographic recording medium in the Y axial direction and the process of the X axial shift multiplex recording by shifting the holographic recording medium in the X axial direction are repeated.

(5) The holographic recording method according to (2) having a process of shifting the holographic recording medium in the X axial direction while keeping the incident optical axis of the object beam, the incident optical axis of the reference beam, and the rotational angle of the holographic recording medium constant to carry out the shift multiplex recording in the X axial direction, a process of switching the incident optical axis of the reference beam and the rotational angle of the holographic recording medium corresponding thereto and the process of the Y axial shift multiplex recording by shifting the holographic recording medium in the Y axial direction are repeated.

(6) The holographic recording method according to (2), wherein: the recording layer is partitioned into a plurality of hologram blocks in the X axial direction and the Y axial direction; and in each of the hologram block, a process of X axial shift multiplex recording by shifting the holographic recording medium in the X axial direction while keeping the incident optical axis of the object beam, the incident optical axis of the reference beam and the rotational angle of the holographic recording medium constant and a process of Y axial shift multiplex recording by shifting the holographic recording medium in the Y axial direction are carried out, and whenever the incident optical axis of the reference beam and the rotational angle of the holographic recording medium corresponding thereto are switched, the process of the X axial shift multiplex recording by shifting the holographic recording medium in the X axial direction and the process of the Y axial shift multiplex recording by shifting the holographic recording medium in the Y axial direction are repeated.

(7) A holographic recording apparatus comprising: a laser light source; a beam splitter for splitting a laser beam from the laser light source into a reference beam and an object beam; a reference optical system for guiding the reference beam into a holographic recording medium; and an object optical system for guiding the object beam into the holographic recording medium, wherein the reference optical system comprises a rotating mirror for selectively reflecting the reference beam from the direction of the beam splitter into a plurality of different optical path directions, a lens group for guiding the reference beam in the plurality of different optical paths to an intersection point with the object beam in the vicinity of the holographic recording medium via corresponding different incident optical axes, a rotating stage for supporting the holographic recording medium rotatably with respect to a Y axial direction passing through the intersection point and perpendicular to an optical axial plane including each of the incident optical axes of the reference beam and the object beam, and a control device for synchronously controlling the rotating mirror and the rotating stage so as to keep a relative incident angle of the reference beam from each incident optical axis to the holographic recording medium constant corresponding to the plurality of different optical paths of the reference beam.

(8) The holographic recording apparatus according to (7) further comprising: a translational stage for supporting the rotating stage so as to shift it in an X axial direction and the Y axial direction, when a direction in the optical axial plane and approximately perpendicular to a recording layer of the holographic recording medium represents a Z axis and a direction perpendicular to the Y axis and the Z axis represents an X axis, the translational stage being able to be controlled synchronously with the rotating mirror and the rotating stage by the control device.

(9) A holographic recording medium in which information is recorded by a diffraction grating formed in a recording layer in the vicinity of an intersection point between an incident optical axis of a reference beam and an incident optical axis of an object beam by projecting the reference beam and the object beam thereonto, wherein the diffraction gratings are recorded by deflection multiplex recording so that a plurality of diffracted light beams generates in different directions when a reproduction reference beam is applied at an incident angle of the incident optical axis of the reference beam at the time of recording.

(10) The holographic recording medium according to (9), wherein when a direction in the optical axial plane and perpendicular to an optical axial plane including the incident optical axes of the reference beam and the object beam and also passing through the intersection point represents a Y axis, a direction approximately perpendicular to the recording layer represents a Z axis, and a direction perpendicular to the Y axis and the Z axis represents an X axis, the diffraction gratings recorded by the deflection multiplex recording are in positions successively shifted in the X and Y directions.

(11) The holographic recording medium according to (10), wherein the recording layer is partitioned into a plurality of hologram blocks in the X axial direction and the Y axial direction, and in each of the hologram blocks, the diffraction gratings recorded by the deflection multiplex recording are in positions successively shifted in the X and Y directions.

(12) A method for reproducing a holographic memory comprising the steps of: projecting a reproduction reference beam onto the holographic recording medium according to any one of (9) to (11) at an incident angle of an incident optical axis of a reference beam at the time of recording, and allowing imaging devices to individually receive a plurality of generating diffracted light beams to reproduce a plurality of signals at the same time.

(13) A holographic memory reproducing apparatus comprising: a stage for supporting the holographic recording medium according to any one of (9) to (11); a laser light source; and a reproduction reference optical system for guiding a reproduction reference beam being a laser beam from the laser light source into the holographic recording medium at an incident angle of an incident optical axis of the reference beam, wherein, the reference optical system comprises: a rotating mirror for selectively reflecting the reference beam from the direction of the beam splitter into a plurality of different optical path directions, a lens group for guiding the reproduction reference beam to an intersection point with the object beam in the vicinity of the holographic recording medium via the incident optical axes of the reference beam, and a plurality of imaging devices provided corresponding to a plurality of diffracted light beams generating from the holographic recording medium by projecting the reproduction reference beam, for receiving the corresponding diffracted light and reproducing signals.

(14) The holographic memory reproducing apparatus according to (13), wherein the stage is a translational stage for supporting the holographic recording medium so as to shift in an X axial direction and a Y axial direction, when a direction in the optical axial plane and approximately perpendicular to a recording layer of the holographic recording medium represents a Z axis and a direction perpendicular to the Y axis and the Z axis represents an X axis.

### BRIEF DESCRIPTION OF THE DRAWINGS

FIG. 1 is an optical system diagram showing a holographic recording apparatus according to a first embodiment of the present invention.

FIG. 2 is an enlarged optical layout drawing which shows the relationship between the positional relation among a rotating mirror, a recording medium, and a lens group between them and the rotational angle of the rotating mirror and the recording medium.

FIG. 3 is a side view which schematically shows the relationship between a reference beam, an object beam, a reproduction reference beam, and the rotational angle of the recording medium in the processes of deflection multiplex recording and reproduction according to the first embodiment.

FIG. 4 is a sectional view which schematically shows the process of recording holograms by the deflection multiplex recording using a holographic recording and reproducing apparatus according to the first embodiment and the process of reproducing the holograms;

FIG. 5 is an optical system diagram showing a holographic recording and reproducing apparatus according to a second embodiment;

FIG. 6 is an enlarged plan view which shows a recoding medium, a rotating stage, and an XY stage according to the second embodiment.

FIG. 7 is a perspective view which schematically shows the process of shift multiplex recording on the recording medium according to the second embodiment; and

FIG. 8 is a plan view which schematically shows another example for holographic recording by concurrent use of deflection multiplex and shift multiplex according to the second embodiment.

### BEST MODE FOR CARRYING OUT THE INVENTION

The incident optical axis of an object beam is fixed with respect to a holographic recording medium, and the incident optical axis of a reference beam and the holographic recording medium are rotated in multiple stages with respect to the incident optical axis of the object beam with keeping the relative incident angles between both constant to carry out deflection multiplex recording. Also the holographic recording medium is shifted in X and Y directions along its recording layer to carry out shift multiplex recording.

At the time of reproduction, a reproduction reference beam is applied from the direction of the relative incident angle of the reference beam at the time of recording with respect to the holographic recording medium. Individual imaging devices receive each of a plurality of generated diffracted light beams, so that many data pages are reproduced at a time.

### FIRST EMBODIMENT

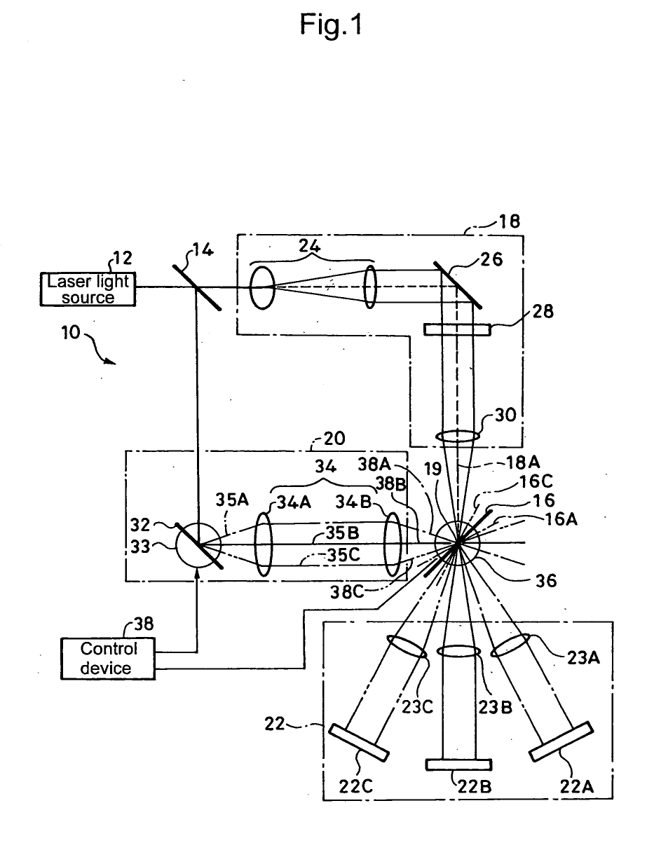

Next, a holographic recording and reproducing apparatus 10 according to a first embodiment of the present invention will be described with reference to FIGS. 1 to 4.

The holographic recording and reproducing apparatus 10 comprises: a laser light source 12; a beam splitter 14 which passes a laser beam emitted from the laser light source 12 to make an object beam, and also reflects it to make a reference beam; an object optical system 18 for guiding the object beam into a holographic recording medium (hereinafter called recording medium) 16; a reference optical system 20 for guiding the reference beam into the recording medium 16; and an image-forming optical system 22 which includes imaging devices 22A, 22B, and 22C which individually receive three diffracted light beams generated when the reference beam is projected onto the recording medium 16, respectively.

The object optical system 18 is configured to include, in the order from the beam splitter 14 side, a beam expander 24 for expanding the beam diameter of an object beam passing through the beam splitter 14; a mirror 26 for reflecting at a right angle a reference beam the beam diameter of which has been expanded by the beam expander 24; a spatial light modulator 28 subjects the object beam reflected by the mirror 26 to spatial light modulation by a bitmap image being a two-dimensional data image encoded in accordance with information to be recorded, and a Fourier lens 30 for Fourier transforming an object beam on which the spatial light modulator 28 has added the bitmap image, and for allowing the light to be focused and incident on the holographic recording medium 16.

The reference optical system 20 comprises a rotating mirror 32 and a lens group 34. The rotating mirror 32 for reflecting the reference beam reflected by the beam splitter 14 in the direction of the recording medium 16 is rotatable so that its reflection angle is deflected in three stages and the reference beam selectively travels in one of three different optical paths 35A, 35B, and 35C. The lens group 34 refracts any reference beam, reflected by the rotating mirror 32 and traveling in the different optical path, so as to be one of incident optical paths 38A, 38B, and 38C incident on an intersection point 19 with the object beam in the vicinity of the recording medium 16.

The holographic recording medium 16 is supported by a rotating stage 36 perpendicularly to an optical axial plane including an incident optical axis 18A of the object beam and incident optical axes 38A to 38C of the reference beam and rotatably with respect to a Y axis passing through the intersection point 19.

In the image-forming optical system 22, imaging lenses 23A, 23B, and 23C being lens structure for further performing a Fourier transform on an image on a Fourier surface of the Fourier lens in optical paths of each diffracted light are disposed between the imaging devices 22A, 22B, and 22C and the intersection point 19, respectively.

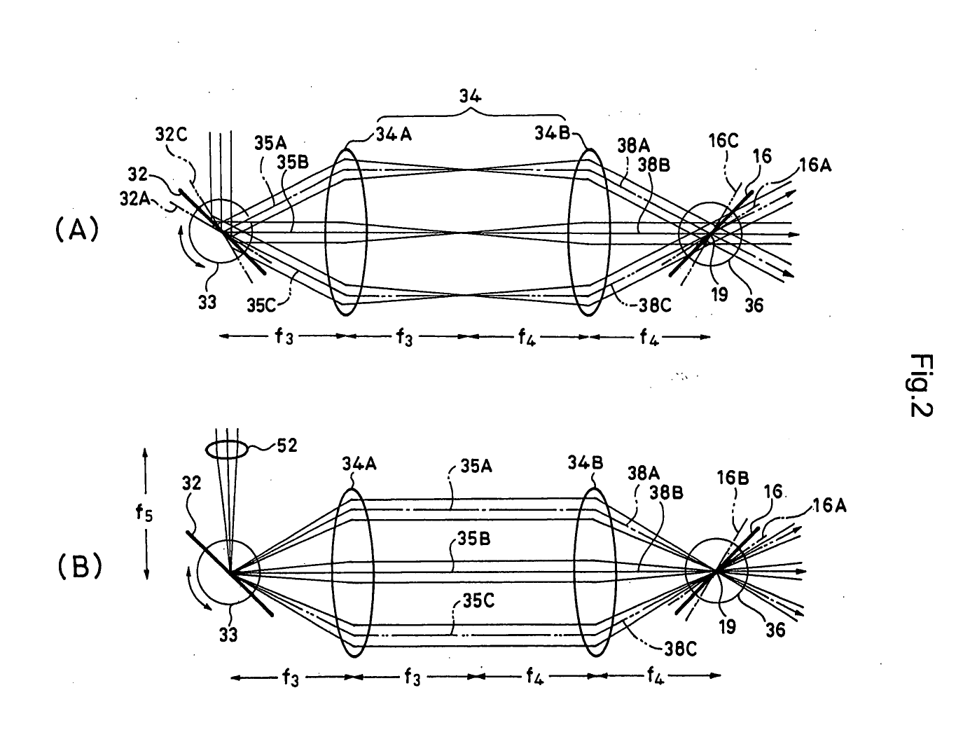

Next, referring to FIG. 2(A), the optical positional relation among the rotating mirror 32, the lens group 34, and the recording medium 16 and the structure of the lens group 34 will be described.

The lens group 34 is composed of a lens (convex lens) 34A with a focal length of f₃ and a lens (convex lens) 34B with a focal length of f₄. These lenses 34A and 34B are disposed in an optical axis connecting the rotation center of the rotating mirror 32 and the intersection point 19.

The distance between the rotation center of the rotating mirror 32 and the lens 34A is set at f₃. The distance between the lenses 34A and 34B is set at f₃+f₄. The distance between the lens 34B and the intersection point 19 is set at f₄.

The rotating mirror 32 is supported by a rotating stage 33 rotatably in a certain range so as to selectively reflect the reference beam from the direction of the beam splitter 14 to the directions of a plurality of different optical axes. A control device 38 synchronously controls both of the rotating stage 33 and the rotating stage 36 for rotatably supporting the recording medium 16 as follows.

In the first embodiment, as shown in FIG. 1, the rotating mirror 32 is configured to reflect the reference beam to the direction of any of the three different optical paths 35A, 35B, and 35C by the rotating stage 33.

The lens group 34 is set so that the reflected light traveling the optical paths 35A, 35B, and 35C, as shown in FIGS. 1 and 2, is incident on the intersection point 19 through the three incident optical axes 38A, 38B, and 38C as the reference beam.

The rotating stage 36 rotates the recording medium 16 via the control device 38 so that the reference beam incident from the incident optical axes 38A, 38B, and 38C is incident on the recording medium 16 with always keeping the same angle.

Next, the processes of carrying out deflection multiplex recording on the recording medium 16 and reproducing the record by the holographic recording and reproducing apparatus 10 will be described.

The laser beam emitted from the laser light source 12 passes through the beam splitter 14 to become an object beam. The spatial light modulator 28 in the object optical system 18 subjects the object beam to spatial light modulation by the information to be recorded (data image), in other words, adds a data image. In this state, the object beam is projected onto the recording medium 16 through the Fourier lens 30.

The rotating mirror 32 reflects the reference beam reflected by the beam splitter 14 to the direction of any of the optical paths 35A, 35B, and 35C.

The reference beam is incident on the recording medium 16 through any of the incident optical axes 38A, 38B, and 38C corresponding to the optical paths 35A, 35B, and 35C.

Thus, the interference between the object beam and the reference beam forms a diffraction grating in the recording medium 16, and hence the information of the data image is recorded by holographic recording.

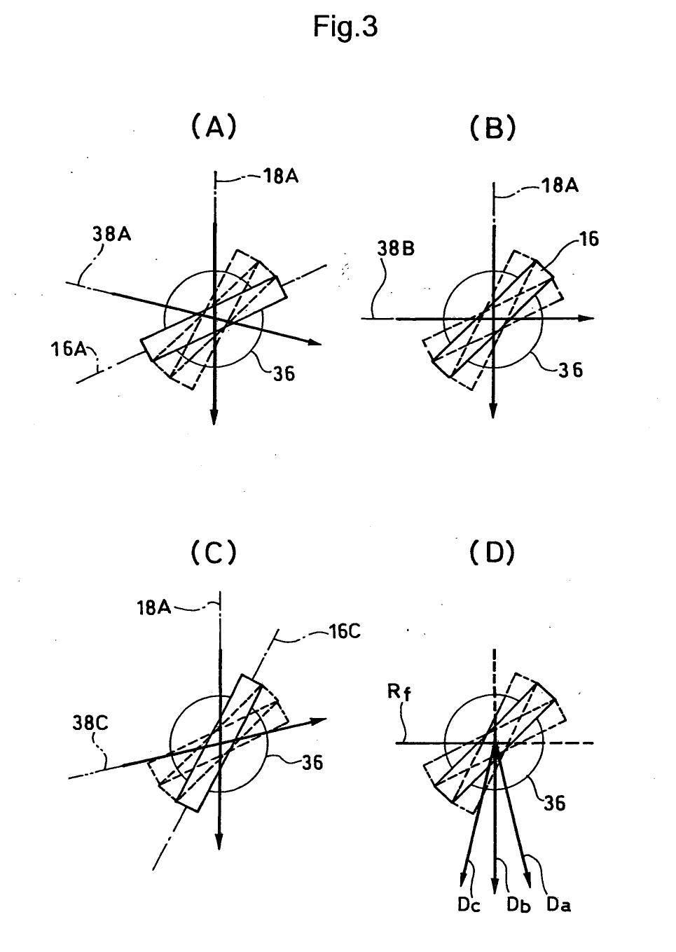

Referring to FIG. 3, the relationship between the incident optical axis 18A of the object beam and the rotational angle of the recording medium 16, when the reference beam is successively incident on the recording medium 16 through the incident optical axes 35A, 35B, and 35C will be described.

First, as shown in FIG. 3(A), the rotating mirror 32 is set in a rotational position so that the reflected light travels the optical path 35A. Thus, the reference beam reflected by the rotating mirror 32 travels the optical path 35A and passes through the lens group 34. The reference beam is incident on the recording medium 16 via the incident optical axis 38A.

At this time, the control device 38 sets the recording medium 16 in a position indicated by a reference number 16A in FIGS. 1, 2, and 3.

Then, the rotating mirror 32 is rotatably set so that the reflected reference beam travels the optical path 35B. Thus, the reference beam is incident on the recording medium 16 from the optical path 35B via the incident optical axis 38B.

At this time, the recording medium 16 is in a position indicated by solid lines in FIG. 3(B).

In any case, the object beam is set so as to be incident directly downward on the recording medium 16 in FIGS. 1 to 3, in other words, via the object beam incident optical axis 18A in the direction perpendicular to the incident optical axis 38B.

Then, the rotating mirror 32 is rotated so that the reflected reference beam travels the optical path 35C. Thus, the reference beam is incident on the recording medium 16 from the optical path 35C via the incident optical axis 38C. At this time, the recording medium 16 is rotated in a position indicated by the reference numeral 16C in FIGS. 1 to 3.

As described above, every relative incident angle between the incident optical axis 38A and the recording medium 16 in the position indicated by the reference number 16A, between the incident optical axis 38B and the recording medium 16 in the position indicated by the solid lines in FIGS. 1 to 3, and between the incident optical axis 38C and the recording medium 16 in the position indicated by the reference number 16C in FIGS. 1 to 3 is kept constant, and only the angle between the relative incident angle and the object optical axis 18A is variable in three stages.

The control device 38 controls the rotational angles of the rotating mirror 32 and the rotating stage 36 so that the rotational angle θ of the rotating mirror 32 and the incident angle on the recording medium 16, in other words, the angular variation φ of the incident optical axis hold the following equation (1):
φ=tan⁻¹(f₃/f₄·tan 2θ) (1)

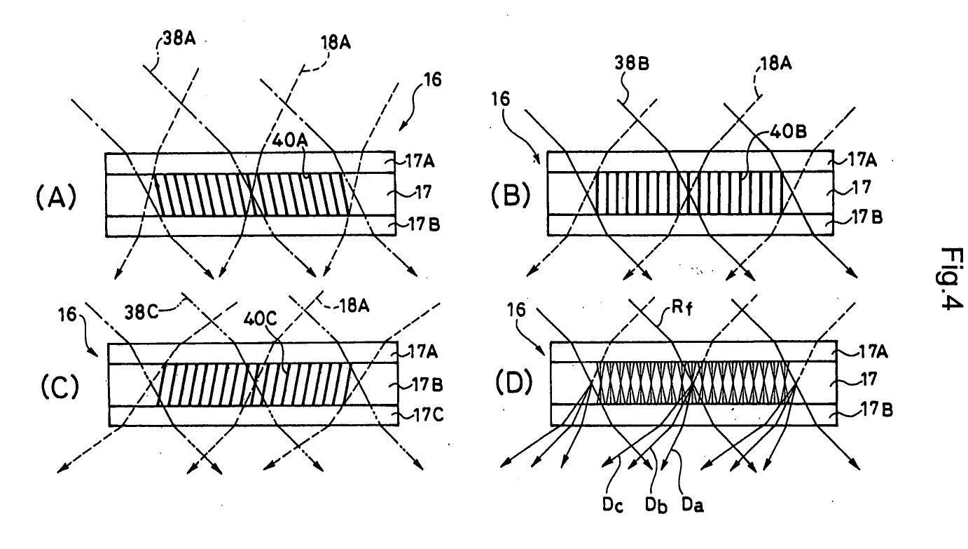

Next, referring to FIGS. 4(A) to (C), the states of diffraction gratings formed in the recording layer 17 of the recording medium 16 by the reference beam incident from the incident optical axis 38A, 38B, or 38C and the object beam incident from the object optical axis 18A will be described. Reference numerals are 17A and 17B in FIGS. 4(A) to (C) indicate substrates sandwiching the recording layer 17.

First, as shown in FIG. 3(A), when the reference beam is incident from the incident optical axis 38A and the object beam is incident from the object beam incident axis 18A, and the recording medium 16 is in the position indicated with the reference numeral 16A in FIG. 3(A), the interference between the reference beam indicated by alternate long and short dashed lines and the object beam indicated by broken lines forms a diffraction grating 40A. in the recording layer 17.

When the reference beam is incident on the recording layer 17 via the incident optical axis 38B in a like manner, a diffraction grating 40B is recorded as shown in FIG. 4(B). When the reference beam is incident via the incident optical axis 38C, a diffraction grating. 40C is recorded in the recording layer 17 as shown in FIG. 4(C).

When the diffraction gratings 40A, 40B, and 40C are successively formed in the recording layer 17 as shown in FIGS. 14(A) to (C), these diffraction gratings 40A, 40B, and 40C are multiplex recorded as shown in FIG. 4(D). The present invention refers to this as “deflection multiplex recording.”

In an actual recording optical system, at least the object beam (signal light) has curved wavefronts. Thus, the states of the diffraction gratings shown in FIGS. 4(A) to (D) are proper only in the vicinity of the object beam incident optical axis 18A, but FIGS. 4(A) to (D) schematically show them.

As described above, each of the incident optical axes 38A to 38C with respect to the recording medium 16 is always kept at a constant angle. Thus, the longitudinal direction of the diffraction grating rotates at φ/2 in response to the counterclockwise rotation of the recording medium 16 at an angle φ in FIG. 3.

In this case, taking a refractive index n of the recording layer of the recording medium 16 in consideration, the rotational angle of the diffraction gratings 40A to 40B is represented by the following equation (2):
±(½) sin⁻¹[1/n·sin (φ₀±φ)]
∓(½) sin⁻¹[1/n·sin φ₀] (2)

Wherein, a complex symbol corresponds to the cases of FIGS. 4(A) and (C) . φ₀ represents the incident angle of the object beam in FIG. 4(B), namely is 45° in the example of FIG. 4.

When a reproduction reference beam Rf is projected along the incident optical axis 38B of the reference beam, as shown in, for example, FIG. 3(D), to the recording layer 17 in which the diffraction gratings 40A to 40C have been recorded by deflection multiplex recording as described above, the diffraction gratings 40A, 40B, and 40C generate diffracted light beams Da, Db, and Dc heading for the imaging devices 22A, 22B, and 22C, respectively.

Accordingly, the imaging devices 22A to 22C detect three data images recorded in the recording layer 17 at the same time, and these images are reproduced into digital information through signal processing such as error correction and decoding.

In this first embodiment, in the diffraction gratings (holograms) recorded in the recording layer 17 as described above, since the relative geometric configurations of the reference beam, the object beam, and the recording medium 16 at the time of recording differ, grating constants and the ratios of wave vectors of the diffraction gratings forming the holograms differ from each other.

Accordingly, it is different from ordinary angular multiplex recording by which only the reference beam is deflected, but the formed diffraction gratings seem in a like manner. Differing in essence, however, the relative positional relationship between the reference beam and the recording medium 16 (incident angle and incident position) does not vary in recording any of the holograms.

The rotational angle φ of the reference beam and the recording medium in recording the holograms (diffraction gratings 40A to 40C) can be set freely as long as the holograms are separately reproduced by Bragg selectivity and separately reproduced reproduction images are spatially and independently reproduced by the image-forming optical system.

The former Bragg selectivity depends on the wavelength line width of record and reproduction light, the thickness of the recording layer, and the geometric optical arrangement at the time of recording. The latter independent reproduction depends on the rotational angle φ and the design of the image-forming optical system.

In other words, the rotational angle φ and hence the maximum number of holograms recorded by deflection multiplex recording are determined in accordance with the design of the image-forming optical system (constraint by the Bragg selectivity is usually inconsiderable and is equal to or less than 1°).

### SECOND EMBODIMENT

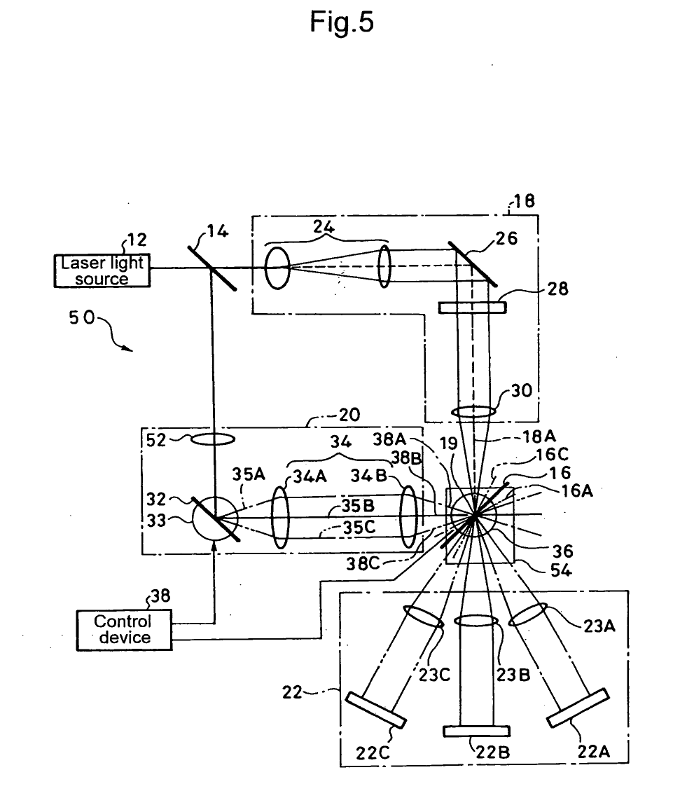

Next, a holographic recording and reproducing apparatus 50 according to a second embodiment of the present invention will be described with reference to FIG. 5.

In FIG. 5, the same reference numerals as those of FIG. 1 refer to identical components to those of the holographic recording and reproducing apparatus 10 shown in FIG. 1, and the description thereof is omitted.

The holographic recording and reproducing apparatus 50 according to the second embodiment differ from the holographic recording and reproducing apparatus 10 according to the first embodiment of FIG. 1 at a point that an optical system of the second embodiment uses both of shift multiplex recording and deflection multiplex recording, though only the deflection multiplex recording is used in the first embodiment.

To be more specific, as contrasted with the first embodiment, in the holographic recording and reproducing apparatus 50 according to the second embodiment, a lens 52 is provided in an optical path of the reference beam between the beam splitter 14 and the rotating mirror 32, and the rotating stage 36 for supporting the recording medium 16 is further supported by an XY stage 54.

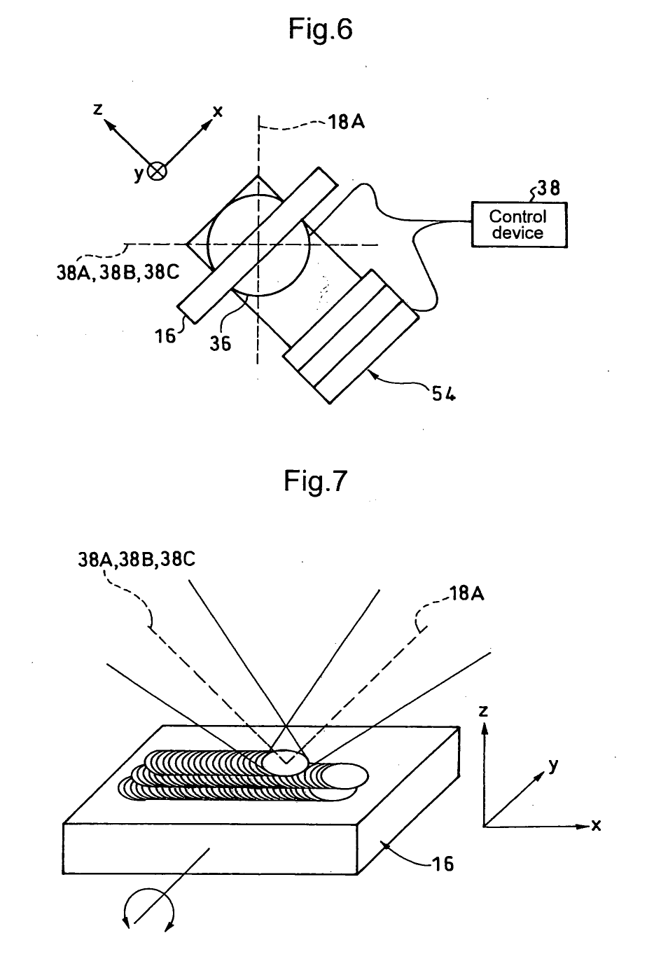

The XY stage 54, as shown in FIG. 6 with enlargement, translationally shifts the rotating stage 36 in an X axial direction and a Y axial direction, when the rotational central axis of the rotating stage 36 is the Y axis, a direction along the recording medium 16 is the X axis, and a perpendicular direction is a Z axis.

When the lens 52 is provided in a reference optical system, as described above, a reference beam in the shape of a spherical wave is incident on the recording medium 16 as shown in FIG. 2(B).

When the holographic recording and reproducing apparatus 50 according to the second embodiment carries out the deflection/shift multiplex recording of a data image, the angles of the rotating mirror 32 and the recording medium 16 are synchronously modulated in a plurality of stages as in the case of the first embodiment, and furthermore the XY stage 54 shifts in the X axial direction and the Y axial direction.

Describing in detail, the control device 38 is a controller for controlling a shift multiplex position to be recorded and the rotational angle of the recording medium 16 based on deflection multiplex. In the process of recording data, the control device 38 controls them on the basis of and in accordance with a program, in which a multiplex order of the data images and the timing of a shift are predetermined, and/or with reference to position and angle detection data (servo signal) from a servo system.

In response to the operation of the recording medium 16 determined by the program and the servo signal, the control device 38 sends a signal at proper timing. The rotational angle of the rotating mirror 32 and the recording medium 16 and the XY stage is controlled by this signal.

As shown in FIG. 7, the reference beam and the object beam at the time of recording are set in the optical axial plane constituted by the Z axis and the X axis, and the XY stage 54 translationally shifts the recording medium 16 in the X axial direction and the Y axial direction.

For example, whenever the XY stage 54 shifts the recording medium 16 to recording positions, the deflection multiplex recording is carried out with the rotating mirror 32 and the recording medium 16 rotated.

There are no particular constraints on an order of the shift multiplex recording in the X axial direction and the shift multiplex recording and deflection multiplex recording in the Y axial direction. It is possible to adopt various multiplex orders such as:
(1) the shift multiplex recording in the X axial direction ->the shift multiplex recording in the Y axial direction -> deflection multiplex recording;
(2) the shift multiplex recording in the Y axial direction -> the shift multiplex recording in the X axial direction -> deflection multiplex recording;
(3) the shift multiplex recording in the X axial direction -> deflection multiplex recording -> the shift multiplex recording in the Y axial direction;
(4) deflection multiplex recording -> the shift multiplex recording in the X axial direction -> the shift multiplex recording in the Y axial direction; and
(5) XY shift multiplex recording in a hologram block (described in later) -> deflection multiplex recording -> accumulate of the hologram blocks (shift multiplex possible).

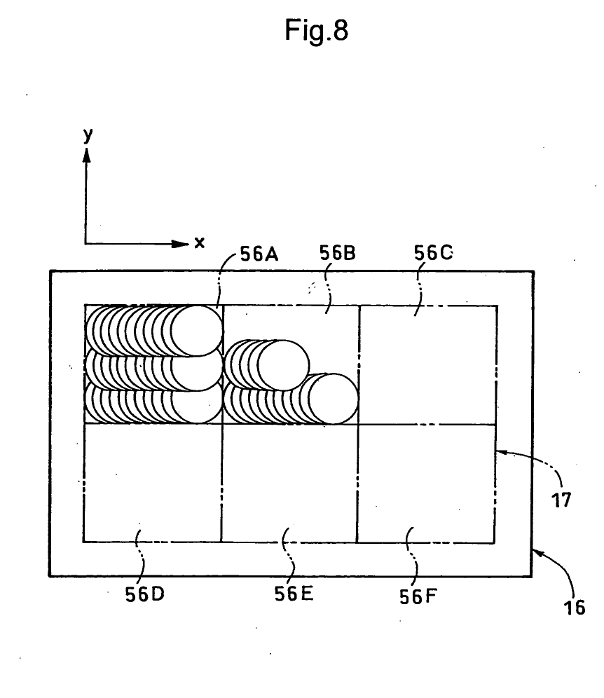

Next, referring to FIG. 8, an example of carrying out the shift multiplex recording and the deflection multiplex recording on a hologram block basis will be described.

In this example, the recording layer 17 of the recording medium 16 is partitioned into, for example, six hologram blocks 56A to 56F by the program, as shown in FIG. 8. The shift multiplex recording and the deflection multiplex recording are carried out successively or at random on a hologram block 56A to 56F basis.

In this example, as compared with the case of the shift multiplex and deflection multiplex recording of the second embodiment, available storage space is slightly reduced because a hologram cannot be formed across the borders between the hologram blocks 56A to 56F. It is possible, however, to record different kinds of data from one hologram block to another hologram block. When the recording layer 17 itself needs post exposure after the multiplex recording, there is an advantage that it is possible to carry out the post exposure on a hologram block basis.

Regarding the shift multiplex in the X axial direction and the Y axial direction, as described above, the distance between adjoining holograms is short in the X axial direction. Thus, giving precedence to the shift multiplex recording in the X axial direction, namely adopting the orders of (1), (3), and (4) described above brings an advantage that it is possible to easily enhance recording and reproducing speed because the total shifting distance of the recording medium is short.

In the case of needing long time to fix a position for the deflection multiplex as compared with the shift multiplex recording, the recording orders of (1) and (2) described above are preferable, and then the recording order of (5) or (3) is preferable.

When the shift multiplex recording is adopted in the holographic recording in general, as described in Non-patent Document 1, shift selectivity in the Y axial direction is lower than that in the X axial direction because of properties caused by the geometric shape of the diffraction gratings formed in the recording layer, in other words, the geometric layout including the wavefront shape of the signal light (object beam) and the reference beam.

The phrase “selectivity is low” shall mean that a shifting distance for detecting diffracted light by a specific hologram is long when the relative position between the reference beam and the recording medium are translationally shifted along an applicable axis in reproducing data. In other words, there is a tendency to reduce the recording density due to the necessity of elongating the distance between adjoining holograms, though mechanical precision required in reproduction is loosened.

In this embodiment, as described above, when the holograms recorded by the shift multiplex and deflection multiplex are reproduced, it is possible to simultaneously obtain three reproduction images in each shift multiplex position as the diffracted light, and the imaging devices 22A, 22B, and 22C individually detect it. Accordingly, a data rate in reproduction is tripled, and the recording density is also tripled at the maximum when the shift selectivity restrains the recording density as in the case with the non-patent document 1.

In the foregoing embodiment, the rotational angles of the rotating mirror 32 and the recording medium 16 are modulated in three stages and an angular interval is constant. The present invention, however, is not limited to it, and the rotational angles of the rotating mirror 32 and the recording medium 16 may be synchronously modulated in a plurality of stages equal to or more than three.

It is not always necessary to equalize the angle between the stages of the rotational angle. The angle can be freely set.

Furthermore, the recording medium 16 is shifted in the X axial direction and the Y axial direction using the XY stage 54 in the second embodiment, but another translational mechanism may be used instead.

Furthermore, both of the embodiments described above relate to the holographic recording and reproducing apparatuses for recording and reproducing the holograms. The present invention, however, is not limited to them, and is applicable to a holographic recording apparatus for just recording or a holographic memory reproducing apparatus for just reproduction as a matter of course.

### INDUSTRIAL APPLICABILITY

In the holographic recording method, the holographic recording apparatus, the holographic recording medium, and the holographic memory reproducing method and apparatus according to the present invention, when the reproduction reference beam is projected onto the holographic recording medium, a plurality of diffracted light beams generates in different directions at the same time. The imaging devices individually receive the diffracted light beams, so that it is possible to simultaneously reproduce a plurality of data pages. Therefore, it is possible to increase a reproduction data rate without using an expensive CCD and the like and without reducing its recording density.

1. A holographic recording method comprising the step of projecting a reference beam and an object beam onto a holographic recording medium to form a diffraction grating in a recording layer in the vicinity of a point of intersection of an incident optical axis of the reference beam and an incident optical axis of the object beam, thereby recording information, wherein
the holographic recording medium is rotated in an optical axial plane including the incident optical axes of the reference beam and the object beam in a plurality of stages with respect to the point of intersection while keeping an incident angle of the object beam constant, and the incident optical axis of the reference beam is switched in a plurality of stages synchronously with a rotational angle of the holographic recording medium so as to keep a relative incident angle to the holographic recording medium constant to carry out deflection multiplex recording.

2. The holographic recording method according to claim 1, wherein
the holographic recording medium is relatively shifted in X and Y axial directions to carry out the deflection multiplex recording and shift multiplex recording, when a rotational central axis of the holographic recording medium represents a Y axis, a direction approximately perpendicular to the recording layer represents a Z axis, and a direction perpendicular to the Y axis and the Z axis represents an X axis.

3. The holographic recording method according to claim 2 having a process of shifting the holographic recording medium in the X axial direction while keeping the incident optical axis of the object beam, the incident optical axis of the reference beam, and the rotational angle of the holographic recording medium constant to carry out the shift multiplex recording in the X axial direction, and then a process of shifting the holographic recording medium in the Y axial direction to carry out the shift multiplex recording in the Y axial direction, wherein
whenever the incident optical axis of the reference beam and the rotational angle of the holographic recording medium corresponding thereto are switched, the process of the X axial shift multiplex recording by shifting the holographic recording medium in the X axial direction and the process of the Y axial shift multiplex recording by shifting the holographic recording medium in the Y axial direction are repeated.

4. The holographic recording method according to claim 2 having a process of shifting the holographic recording medium in the Y axial direction while keeping the incident optical axis of the object beam, the incident optical axis of the reference beam, and the rotational angle of the holographic recording medium constant to carry out the shift multiplex recording in the Y axial direction, and then a process of shifting the holographic recording medium in the X axial direction to carry out the shift multiplex recording in the X axial direction, wherein
whenever the incident optical axis of the reference beam and the rotational angle of the holographic recording medium corresponding thereto are switched, the process of the Y axial shift multiplex recording by shifting the holographic recording medium in the Y axial direction and the process of the X axial shift multiplex recording by shifting the holographic recording medium in the X axial direction are repeated.

5. The holographic recording method according to claim 2 having a process of shifting the holographic recording medium in the X axial direction while keeping the incident optical axis of the object beam, the incident optical axis of the reference beam, and the rotational angle of the holographic recording medium constant to carry out the shift multiplex recording in the X axial direction,
a process of switching the incident optical axis of the reference beam and the rotational angle of the holographic recording medium corresponding thereto and the process of the Y axial shift multiplex recording by shifting the holographic recording medium in the Y axial direction are repeated.

6. The holographic recording method according to claim 2, wherein:
the recording layer is partitioned into a plurality of hologram blocks in the X axial direction and the Y axial direction; and
in each of the hologram block, a process of X axial shift multiplex recording by shifting the holographic recording medium in the X axial direction while keeping the incident optical axis of the object beam, the incident optical axis of the reference beam and the rotational angle of the holographic recording medium constant and a process of Y axial shift multiplex recording by shifting the holographic recording medium in the Y axial direction are carried out, and whenever the incident optical axis of the reference beam and the rotational angle of the holographic recording medium corresponding thereto are switched, the process of the X axial shift multiplex recording by shifting the holographic recording medium in the X axial direction and the process of the Y axial shift multiplex recording by shifting the holographic recording medium in the Y axial direction are repeated.

7. A holographic recording apparatus comprising: a laser light source; a beam splitter for splitting a laser beam from the laser light source into a reference beam and an object beam; a reference optical system for guiding the reference beam into a holographic recording medium; and an object optical system for guiding the object beam into the holographic recording medium, wherein
the reference optical system comprises
a rotating mirror for selectively reflecting the reference beam from the direction of the beam splitter into a plurality of different optical path directions,
a lens group for guiding the reference beam in the plurality of different-optical paths to an intersection point with the object beam in the vicinity of the holographic recording medium via corresponding different incident optical axes,
a rotating stage for supporting the holographic recording medium rotatably with respect to a Y axial direction passing through the intersection point and perpendicular to an optical axial plane including each of the incident optical axes of the reference beam and the object beam, and
a control device for synchronously controlling the rotating mirror and the rotating stage so as to keep a relative incident angle of the reference beam from each incident optical axis to the holographic recording medium constant corresponding to the plurality of different optical paths of the reference beam.

8. The holographic recording apparatus according to claim 7 further comprising:
a translational stage for supporting the rotating stage so as to shift it in an X axial direction and the Y axial direction, when a direction in the optical axial plane and approximately perpendicular to a recording layer of the holographic recording medium represents a Z axis and a direction perpendicular to the Y axis and the Z axis represents an X axis, the translational stage being able to be controlled synchronously with the rotating mirror and the rotating stage by the control device.

9. A holographic recording medium in which information is recorded by a diffraction grating formed in a recording layer in the vicinity of an intersection point between an incident optical axis of a reference beam and an incident optical axis of an object beam by projecting the reference beam and the object beam thereonto, wherein
the diffraction gratings are recorded by deflection multiplex recording so that a plurality of diffracted light beams generates in different directions when a reproduction reference beam is applied at an incident angle of the incident optical axis of the reference beam at the time of recording.

10. The holographic recording medium according to claim 9, wherein
when a direction in the optical axial plane and perpendicular to an optical axial plane including the incident optical axes of the reference beam and the object beam and also passing through the intersection point represents a Y axis, a direction approximately perpendicular to the recording layer represents a Z axis, and a direction perpendicular to the Y axis and the Z axis represents an X axis,
the diffraction gratings recorded by the deflection multiplex recording are in positions successively shifted in the X and Y directions.

11. The holographic recording medium according to claim 10, wherein
the recording layer is partitioned into a plurality of hologram blocks in the X axial direction and the Y axial direction, and
in each of the hologram blocks, the diffraction gratings recorded by the deflection multiplex recording are in positions successively shifted in the X and Y directions.

12. A method for reproducing a holographic memory comprising the steps of:
projecting a reproduction reference beam onto the holographic recording medium according to claim 9 at an incident angle of an incident optical axis of a reference beam at the time of recording, and allowing imaging devices to individually receive a plurality of generating diffracted light beams to reproduce a plurality of signals at the same time.

13. A holographic memory reproducing apparatus comprising:
a stage for supporting the holographic recording medium according to claim 9;
a laser light source; and
a reproduction reference optical system for guiding a reproduction reference beam being a laser beam from the laser light source into the holographic recording medium at an incident angle of an incident optical axis of the reference beam,
wherein, the reference optical system comprises:
a rotating mirror for selectively reflecting the reference beam from the direction of the beam splitter into a plurality of different optical path directions,
a lens group for guiding the reproduction reference beam to an intersection point with the object beam in the vicinity of the holographic recording medium via the incident optical axes of the reference beam, and
a plurality of imaging devices provided corresponding to a plurality of diffracted light beams generating from the holographic recording medium by projecting the reproduction reference beam, for receiving the corresponding diffracted light and reproducing signals.

14. The holographic memory reproducing apparatus according to claim 13, wherein
the stage is a translational stage for supporting the holographic recording medium so as to shift in an X axial direction and a Y axial direction, when a direction in the optical axial plane and approximately perpendicular to a recording layer of the holographic recording medium represents a Z axis and a direction perpendicular to the Y axis and the Z axis represents an X axis.

15. A method for reproducing a holographic memory comprising the steps of:
projecting a reproduction reference beam onto the holographic recording medium according to claim 10 at an incident angle of an incident optical axis of a reference beam at the time of recording, and allowing imaging devices to individually receive a plurality of generating diffracted light beams to reproduce a plurality of signals at the same time.

16. A method for reproducing a holographic memory comprising the steps of:
projecting a reproduction reference beam onto the holographic recording medium according to claim 11 at an incident angle of an incident optical axis of a reference beam at the time of recording, and allowing imaging devices to individually receive a plurality of generating diffracted light beams to reproduce a plurality of signals at the same time.

17. A holographic memory reproducing apparatus comprising:
a stage for supporting the holographic recording medium according to claim 10;
a laser light source; and
a reproduction reference optical system for guiding a reproduction reference beam being a laser beam from the laser light source into the holographic recording medium at an incident angle of an incident optical axis of the reference beam,
wherein, the reference optical system comprises:
a rotating mirror for selectively reflecting the reference beam from the direction of the beam splitter into a plurality of different optical path directions,
a lens group for guiding the reproduction reference beam to an intersection point with the object beam in the vicinity of the holographic recording medium via the incident optical axes of the reference beam, and
a plurality of imaging devices provided corresponding to a plurality of diffracted light beams generating from the holographic recording medium by projecting the reproduction reference beam, for receiving the corresponding diffracted light and reproducing signals.

18. A holographic memory reproducing apparatus comprising:
a stage for supporting the holographic recording medium according to claim 11;
a laser light source; and
a reproduction reference optical system for guiding a reproduction reference beam being a laser beam from the laser light source into the holographic recording medium at an incident angle of an incident optical axis of the reference beam,
wherein, the reference optical system comprises:
a rotating mirror for selectively reflecting the reference beam from the direction of the beam splitter into a plurality of different optical path directions,
a lens group for guiding the reproduction reference beam to an intersection point with the object beam in the vicinity of the holographic recording medium via the incident optical axes of the reference beam, and
a plurality of imaging devices provided corresponding to a plurality of diffracted light beams generating from the holographic recording medium by projecting the reproduction reference beam, for receiving the corresponding diffracted light and reproducing signals.

19. The holographic memory reproducing apparatus according to claim 17, wherein
the stage is a translational stage for supporting the holographic recording medium so as to shift in an X axial direction and a Y axial direction, when a direction in the optical axial plane and approximately perpendicular to a recording layer of the holographic recording medium represents a Z axis and a direction perpendicular to the Y axis and the Z axis represents an X axis.

20. The holographic memory reproducing apparatus according to claim 18, wherein
the stage is a translational stage for supporting the holographic recording medium so as to shift in an X axial direction and a Y axial direction, when a direction in the optical axial plane and approximately perpendicular to a recording layer of the holographic recording medium represents a Z axis and a direction perpendicular to the Y axis and the Z axis represents an X axis.
